(19) United States
(12) Patent Application Publication
(10) Pub. No.: US 2010/0225600 A1
(43) Pub. Date: Sep. 9, 2010

(54) Display Structure with Direct Piezoelectric Actuation

(75) Inventors: Xunhu Dai, Gilbert, AZ (US); Giles Davis, Mundelein, IL (US); Steve Emmert, Crystal Lake, IL (US); Brian Hassemer, Gurnee, IL (US)

Correspondence Address: Tolpin & Partners, PC, 11 S. LaSalle Street, Suite 2900, Chicago, IL, 60603, US

(73) Assignee: Motorola Inc., Shaumburg, IL (US)

(21) Appl. No.: 12/400,484

(22) Filed: Mar. 9, 2009

(51) Int. Cl. G06F 3/041

(52) U.S. Cl. 345/173

(57) ABSTRACT

A user friendly display structure (100) for an electronic device (102), such as a touch screen hand held communications device, is provided with piezoelectric elements (126) bonded or otherwise secured directly to the back of a display module (112) generates effective haptics and sound localized to the display area. Actuation of piezoelectric elements (126) in the display structure (100) generates bending motion of the entire display structure (100) which provides haptics feedback to fingers operating on the display structure (100) as well as generates sound by turning part or the entire display into a speaker.

### BACKGROUND OF THE INVENTION

1. Field of the Disclosure

The disclosure relates in general to handheld electronic devices, and more particularly, to providing touch screen haptic feedback and audio to hand held electronic devices.

2. Background Art

Over the years various hand held electronic devices, have been developed or suggested, such as hand held communication devices, including radiotelephones, cellular (cell) phones, mobile phones, smart phones, personal digital assistant (PDA), wireless devices, two way pagers, and touch screen mobile devices. These conventional hand held electronic devices have met with various degrees of success.

Many conventional electronic devices have small displays which are difficult to read as well as difficult to input information or data via a touch screen. Some newer hand held electronic devices have a large display with a touch screen having a touch sensitive input surface. It is desirable that the area of the display be very large or occupy nearly the entire surface for better view and that the electronic device deliver good audio and haptics including feel, touch feedback and sensitivity to the user. Conventional hand held electronic devices and touch screen mobile devices, however, do not provide effective localized haptics and audio at the user interface. Furthermore, conventional hand held electronic devices are often difficult to assemble and expensive to manufacture.

It is, therefore, desirable to provide an improved display structure for an electronic device which overcomes most, if not all, of the preceding problems.

### SUMMARY OF THE INVENTION

An improved display structure for an electronic device is provided that is user-friendly, reliable, and effective. The novel display structure is simple to use, easy to manufacture and economical. Advantageously, the special display structure can generate excellent localized haptics and sound to the display area. Desirably, novel display structure has direct bonding of piezoelectric elements to the back of the display which simplifies the structure and assembly.

Preferably, actuation of piezoelectric elements in the display structure generates bending motion of the entire display structure which can provide effective haptic feedback to fingers operating on the display structure as well as generate enhanced sound including voice, tones and music by turning part or the entire display into a speaker.

The inventive display structure for an electronic device can comprise a touch sensitive lens having an input lens surface for generating a signal in response to a manually engageable input from a user when the user touches the lens with a finger. The display structure can also have a display module comprising a light emitting display for emitting light forming an image on the lens in response to the signal as well as can have a bezel which can provide a back plate, with or without a rim, for holding the light emitting display, such as by using adhesive. Significantly, piezoelectric elements can be secured directly to the display module for generating bending motion to the display structure and providing haptic feedback to one or more of the user's fingers touching the display surface and for transmitting acoustic waves from the lens surface.

When the surface of the lens is in contact of human ear the piezoelectrically actuated display structure also serves as a bone conduction speaker, in addition to being a conventional acoustic speaker which sends air acoustic wave to the user's ear canal. Bone conduction is the conduction of sound, or transmitting of acoustic waves, to the inner ear through the bones of the skull.

The piezoelectric elements can be bonded to a back of the display module, or to the light emitting display or to the bezel. The bezel can be a metal bezel or a plastic bezel. The display is preferably an organic light emitting diode (OLED). Desirably, the light emitting display is solid without gaps, air pockets, or voids. Advantageously, the display structure is a bendable display structure.

The lens can include a glass screen, touchpad, and/or a keyboard. The images displayed on the lens can be black and/or colored graphics, text, numbers, and/or alpha numeric images.

The electronic device can be an a radiotelephone, a cellular (cell) phone, a mobile phone, smart phone, personal digital assistant (PDA), an electronic device with a clamshell configuration, a mobile communications device, wireless device, wireless e-mail device, a two way pager, or other hand held electronic device.

In the illustrated embodiment, the display structure has optically clear adhesive (OCA) sandwiched between and bonding the lens to the light emitting display. A chassis, such as a circuit board and/or phone chassis, can be spaced from the piezoelectric elements in a direction opposite the display module and lens. A housing can be provided for holding the lens, chassis, and display module. A gasket can be positioned between and sealing the housing to a peripheral portion of the lens.

The novel display structure as described and claimed herein achieves unexpected surprisingly good results.

A more detailed explanation of the invention is provided in the following description and appended claims.

### BRIEF DESCRIPTION OF THE DRAWINGS

FIG. 1 is a cross-sectional end view of a display structure for an electronic device in accordance with principle of the present invention.

FIG. 2 is an exploded assembly view of the display structure as viewed from the top.

FIG. 3 is an exploded assembly view of the display structure as viewed from the bottom.

FIG. 4 is an exploded assembly view of the display structure assembly.

### DETAILED DESCRIPTION OF THE INVENTION

The following is a detailed description of the preferred embodiment of the invention and best mode for practicing the invention.

While this invention is susceptible of embodiment in many different forms, there is shown in the drawings and described herein in detail, specific embodiments of the invention with the understanding that the present disclosure is to be considered as an exemplification and is not intended to be limited to the illustrated embodiments.

It will be understood that the drawings are merely representations of the invention, and some of the parts and components may have been distorted from actual scale for purposes of pictorial clarity.

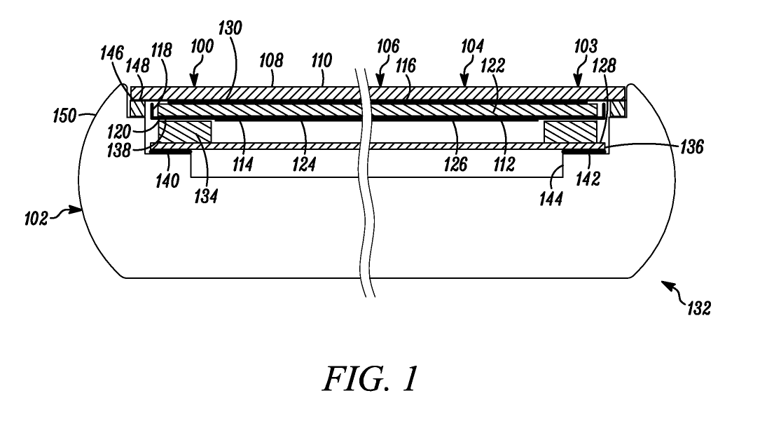

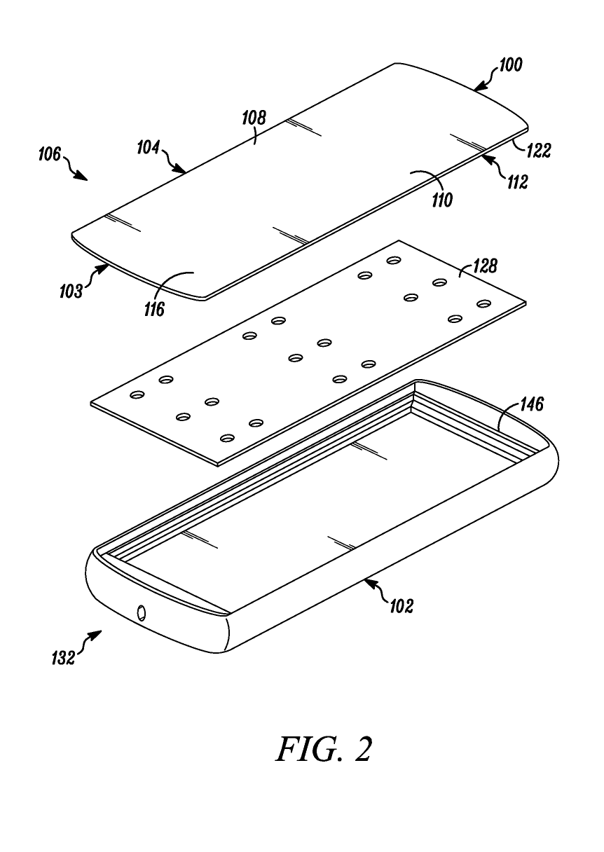

Referring to FIGS. 1-4 of the drawings, a display structure 100 for an electronic device 102 is shown with a display structure assembly 103 providing a user interface 104 which can provide haptics and audio with direct piezoelectric bending action for allowing substantial transfer of mechanical vibration energy. The user interface of the display structure assembly can comprises a touch sensitive lens 106 having an input lens surface 108 and opposite bonding surface 109. Touch sensors 110 can be integrated to either the input surface 108 or the opposite bonding surface 109 of the lens. The touch sensor 110 generates a signal in response to a manually engageable haptic input from a user when the user touches the lens with a finger. The user interface of the display structure assembly can also include a display module 112 comprising an organic light emitting display (OLED) 114 for emitting light forming an image 116 on the lens in response to the signal. The OLED preferably occupies a substantial portion of a surface of the electronic device. The user interface can also have a display bezel 118 that can provide a back plate 120 for securely holding the light emitting display, such as by using adhesive. The display structure assembly operates and functions to provide a speaker 122 in response to vibrations generated by piezoelectric elements 126.

The OLED has no or minimum gaps, air pockets, spaces or voids, inside its structure. Conventional display, such as a liquid crystal display (LCD) can not typically be used in the display structure of this invention, because of the existence of multiple internal gaps, air pockets, spaces or voids in a LCD that undesirably damp or block vibrations. The OLED comprising the display module can substantially transfer mechanical vibration from one side to the other.

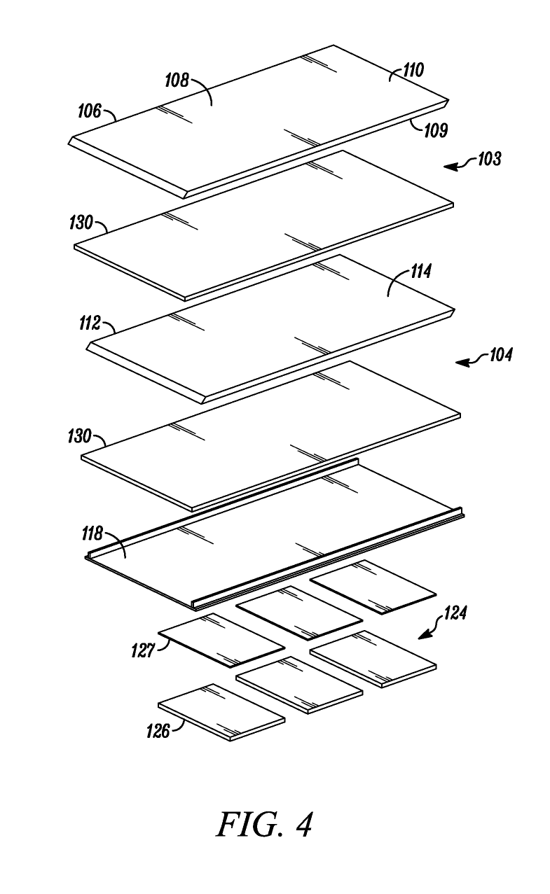

The piezoelectric elements can cooperate with each other to provide an actuator 124 (FIGS. 1, 3, and 4). The piezoelectric elements can occupy a substantially large portion or most of the OLED for causing directing bending action of substantially the entire display structure. Desirably, the piezoelectric elements deliver effective localized haptics and audio to the user interface in response to piezoelectric actuation of the piezoelectric elements. The piezoelectric elements can be bonded by epoxy 127 (FIG. 4) or otherwise secured directly to and against the display module for: (a) generating bending motion to the display structure; (b) providing excellent haptic feedback to the user's finger touching the lens surface; and (c) for transmitting acoustical vibration for generating excellent sound from the lens surface. The piezoelectric elements can comprise a single layer of piezoelectric elements or multiple layers of piezoelectric elements.

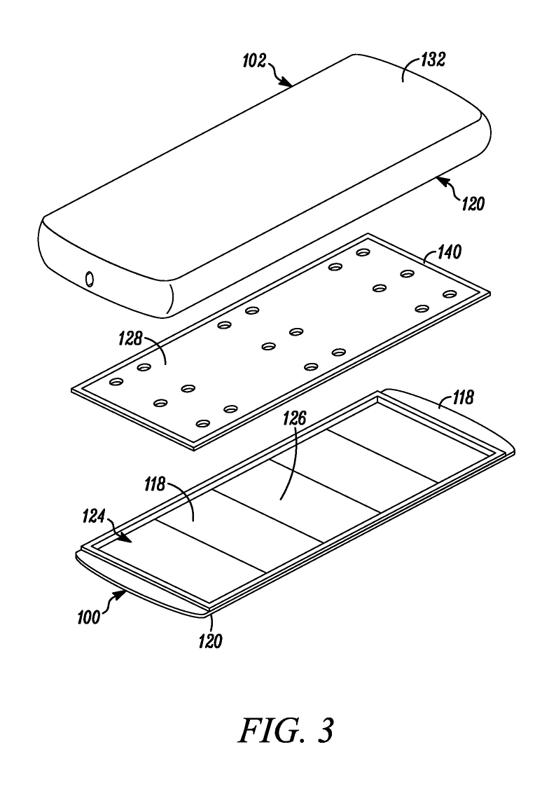

In the preferred embodiment, a phone chassis 128 (FIGS. 1 and 3) is positioned away and spaced from the piezoelectric elements in a direction opposite the display module and lens. The electronic device with a phone chassis can be a handheld phone, such as a cellular phone, a mobile phone, and/or a smart phone.

Optically clear adhesive (OCA) 130 (FIG. 1) can be sandwiched between the lens and the light emitting display to bond the lens to the light emitting display. A housing 132 can be provided for holding the phone chassis and display structure assembly which comprises the touch sensitive lens, light emitting display, bezel and piezoelectric elements bonded to bezel. An adhesive coated foam gasket 134 which can provide a spacer can be positioned between, separating and sealing an upper peripheral portion 136 of the phone chassis to a peripheral back portion 138 of the bezel of the display module. A lower gasket 140 can be positioned between, separating and sealing a lower peripheral portion 142 of the phone chassis and a lower ledge 144 of the housing. An upper adhesive gasket 146 can be positioned between, separating and sealing a lower peripheral edge 148 of the lens and an upper ledge 150 of the housing.

In use, when the user touches the lens, the user interface and piezoelectric elements of the actuator cooperate with each other to generate clear viewable images on the display, provide superior haptics feedback to the user's finger touching the display, and deliver excellent sound to the user.

The piezoelectric elements which are directly bonded to the display module generate bending motion of the entire display structure and substantial mechanical vibrations. The display structure allows substantial transfer of mechanical vibrations to the user interface.

The piezoelectric actuation delivers effective localized haptics and audio at the user interface through the display structure. The load on the display surface has minimum effect on the magnitude of sound and haptics due to the directly bending of the display structure with large area piezoelectric elements.

Desirably, the display glass vibrate to create the audio. The piezoelectric elements bonded on one side of the display can cause the display surface of the other side of the display module to bend.

Among the many advantages of the inventive display structure with piezoelectric actuation for electronic devices are:
1. Outstanding generation of effective haptics with superb sense of touch and superior sound localized to the display area.
2. Simplification of structure and assembly, by direct bonding of piezoelectric elements to the back of the display.
3. Actuation of piezoelectric elements in the display structure generate bending motion of the entire display structure which can provide enhanced haptics feedback to fingers operating on the display structure as well as generate excellent sound (audio) by turning part or the entire display into a speaker
4. No need of normal earpiece or conventional loud speakers
5. No sweet spot issue associated with the fixed acoustic port that delivers sound waves from earpiece speaker.
6. The speaker can comprise a bone conduction speaker.
7. Excellent audio clarity in both noisy and quiet environments.
8. Superior capability.
9. Superb performance.
10. Reliable.
11. Light weight.
12. Portable.
13. User friendly.
14. Easy to use.
15. Comfortable.
16. Compact.
17. Convenient.
18. Durable
19. Economical.
20. Attractive.
21. Efficient.
22. Effective.

Although embodiments of the invention have been shown and described, it is to be understood that various modifications, substitutions, and rearrangements of parts, components, as well as other uses of the display structure and electronic device, can be made by those skilled in the art without departing from the novel spirit and scope of this invention. The preceding description merely explains and illustrates the invention and the invention is not limited thereto except insofar as the appended claims are so limited.

What is claimed is:

1. A display structure for an electronic device, comprising:
a touch sensitive lens having an input lens surface for generating a signal in response to a manually engageable input from a user when the user touches the lens with a finger;
a display module comprising
a light emitting display for emitting light forming an image on said lens in response to the signal;
a bezel secured to said light emitting display; and
piezoelectric elements secured directly to and against said display module for generating bending motion to the display structure and providing haptic feedback to the user's finger touching the lens surface and for transmitting acoustical vibration waves from the lens surface.

2. The display structure of claim 1 wherein said electronic device is a handheld electronic device selected from the group consisting of with a cellular phone, a mobile phone, a smart phone, a personal digital assistant, an electronic device with a clamshell configuration, mobile communications device, wireless device, wireless e-mail device, a two way pager, and combinations thereof.

3. The display structure of claim 1 wherein said lens includes a portion selected form the group consisting of a glass screen, touchpad, and a keyboard.

4. The display structure of claim 1 wherein said image is selected from the group consisting of graphics, text, numbers, alpha numeric images, and combinations thereof.

5. The display structure of claim 1 wherein said display is an organic light emitting diode (OLED).

6. The display structure of claim 1 wherein said piezoelectric elements are bonded to a back of the display module.

7. The display structure of claim 1 wherein said piezoelectric elements are bonded to the light emitting display.

8. The display structure of claim 1 wherein said piezoelectric elements are bonded to the bezel.

9. The display structure of claim 1 wherein said piezoelectric elements are selected from the group consisting of a single layer of piezoelectric elements and multiple layers of piezoelectric elements.

10. The display structure of claim 1 wherein:
said bezel is a metal bezel;
said light emitting display is solid and absent of gaps, air pockets, and voids; and
said display structure is a bendable display structure.

11. The display structure of claim 1 wherein said lens surface transmitting the acoustical vibration waves further comprises a bone conduction speaker.

12. A display structure for an electronic device, comprising:
a touch sensitive lens having an input lens surface for generating a signal in response to a manually engageable input from a user when the user touches the lens with a finger;
a display module comprising
a light emitting display for emitting light forming an image on said lens in response to the signal; and
a bezel holding said light emitting display;
piezoelectric elements secured directly to and against said display module for generating bending motion to the display structure and providing haptic feedback to the user's finger touching the lens surface and for transmitting acoustical vibration waves from the lens surface;
optically clear adhesive sandwiched between and bonding the lens to the light emitting display;
a chassis spaced from said piezoelectric elements in a direction opposite said display module and lens; and
a housing for holding said lens, chassis, and display module; and
said electronic device is a mobile manually graspable handheld electronic device.

13. The display structure of claim 12 including a gasket positioned between and sealing the housing to a peripheral portion of the lens.

14. The display structure of claim 12 wherein said chassis is a circuit board.

15. The display structure of claim 12 wherein said chassis is a phone chassis.

16. An display structure for an electronic device, comprising:
a display structure assembly comprising a user interface providing haptics and audio with direct piezoelectric bending action for allowing substantial transfer of mechanical vibration energy, said user interface comprising
a touch sensitive lens having an input lens surface for generating a signal in response to a manually engageable input from a user when the user touches the lens with a finger;
a display module comprising
an organic light emitting display (OLED) for emitting light forming an image on said lens in response to the signal;
a bezel holding said light emitting display; and
piezoelectric elements cooperating with each other to provide an actuator occupying a substantially large portion of the OLED for causing directing bending action of substantially the entire display structure; said piezoelectric elements delivering localized haptic and audio to the user interface in response to piezoelectric actuation of said piezoelectric elements, said piezoelectric elements secured directly to and against said display module for generating bending motion to the display structure and providing haptic feedback to the user's finger touching the lens surface and for transmitting acoustical vibration waves from the lens surface;
optically clear adhesive sandwiched between and bonding the lens to the light emitting display; and
a phone chassis spaced from said piezoelectric elements in a direction opposite said display module and lens; and
said electronic device is a handheld phone selected form the group consisting of a cellular phone, a mobile phone, and a smart phone.

17. The display structure of claim 16 wherein said OLED occupies a substantial portion of a surface of the electronic device.

18. The display structure of claim 16 including touch sensors integrated with a surface of the lens.

19. The display structure of claim 16 wherein said piezoelectric elements are selected from the group consisting of a single layer of piezoelectric elements and multiple layers of piezoelectric elements.

20. The display structure of claim 16 including
a housing for holding said display structure assembly and said phone chassis;
an adhesive coated foam gasket providing a spacer positioned between, separating and sealing an upper peripheral portion of the phone chassis to a peripheral back portion of the bezel of said display module; and
a lower gasket positioned between, separating and sealing a lower peripheral portion of the phone chassis and a ledge of the housing.
